(19) United States
(12) Patent Application Publication
(10) Pub. No.: US 2026/0045105 A1
(43) Pub. Date: Feb. 12, 2026

(54) METHOD AND SYSTEM FOR PROCESSING IMAGES

(71) Applicant: COMPAGNIE GERVAIS DANONE, Gif-sur-Yvette (FR)

(72) Inventors: Adi LEV, Ganei Hadar (IL); Jacob NAPARSTEK, Tel Aviv (IL); Israel LORENZ, Hemed (IL); Maya ETUSH, Petah Tikva (IL); Danor BEKER, Tel Aviv (IL)

(73) Assignee: COMPAGNIE GERVAIS DANONE, Gif-sur-Yvette (FR)

(21) Appl. No.: 19/359,823

(22) Filed: Oct. 16, 2025

Related U.S. Application Data
(63) Continuation of application No. PCT/IL2024/050383, filed on Apr. 17, 2024.
(60) Provisional application No. 63/459,936, filed on Apr. 17, 2023.

(51) Int. Cl. G06V 20/68; G06F 3/04842; G06V 10/776; G06V 30/10

(52) U.S. Cl. CPC G06V 20/68; G06F 3/04842; G06V 10/776; G06V 30/10

(57) ABSTRACT

A method of processing an image, comprises receiving image data from a subject at a remote location, and analyzing the image data to identify therein a content pertaining to a food item. A set of subject descriptor features specific to the subject is obtained, and a trained machine learning procedure is applied to the identified food item and the set to provide a score describing a response of the subject to the food item. The method generates processed image data containing the score superimposed on at least a portion of the received image data, and transmits the image data to a display device viewable by the subject at the remote location.

### RELATED APPLICATION

This application claims the benefit of priority of U.S. Provisional Ser. No. 63/459,936 filed on Apr. 17, 2023, the contents of which are incorporated herein by reference in their entirety.

### FIELD AND BACKGROUND OF THE INVENTION

The present invention, in some embodiments thereof, relates to image processing and, more particularly, but not exclusively, to a method and system for processing an image for the purpose of providing a personalized diet to an individual.

Computerized dietary techniques are disclosed, for example, in International Publication No. WO2002100266 discloses a dietary technique which employs a database of reference human factors. A computer receives user data on the human factors and predicts a selected characteristic of blood of the user dependent upon user data and measured blood characteristics, to generate a prediction model. The prediction model is then interrogated to generate and display a predicted blood characteristic dependent upon input human factor data. Also disclosed is the use of a database which includes a prediction model on a selected blood characteristic as a function of a human factor.

International Publication No. WO2015/166489, the contents of which are hereby incorporated by reference, discloses a method of predicting a response of a subject to food, by selecting a food to which a response of the subject is unknown, and using information describing the subject and knowledge of responses of other subjects to foods to estimate the response of the subject to the selected food.

### SUMMARY OF THE INVENTION

According to an aspect of some embodiments of the invention there is provided a method of processing an image. The method comprises receiving image data from a subject at a remote location, and analyzing the image data to identify therein a content pertaining to a food item. The method also comprises obtaining a set of subject descriptor features specific to the subject, and applying a trained machine learning procedure to the identified food item and the set to provide a score describing a response of the subject to the food item. The method generates processed image data containing the score superimposed on at least a portion of the received image data, and transmits the image data to a display device viewable by the subject at the remote location.

According to some embodiments of the invention the image data are analyzed by identifying non-textual content in the image.

According to some embodiments of the invention the image data are analyzed by applying character recognition to a textual content in the image.

According to some embodiments of the invention the image data comprises a stream of image data, and the processed image data comprises a stream of processed image data.

According to some embodiments of the invention the processed image data are generated by superimposing also an identification of the food item.

According to some embodiments of the invention the image data are analyzed by identifying in the image data different contents pertaining to different food items, wherein the application of trained machine learning procedure comprises applying the trained machine learning procedure separately to each of the food items to provide a score describing a response of the subject to each of the food items, and wherein the processed image data are generated by superimposing each of the scores on at least a portion of the received image.

According to some embodiments of the invention at least two of the different contents are in a single image frame.

According to some embodiments of the invention at least two of the different contents are in different image frames.

According to some embodiments of the method comprises calculating a meal score for a selection of the food items, and transmitting the meal score to the display device.

According to some embodiments of the invention the selection comprises all the food items.

According to some embodiments of the invention the selection comprises a portion of the food items. According to some embodiments of the invention the portion is selected automatically. According to some embodiments of the method comprises receiving the portion from the subject at the remote location.

According to an aspect of some embodiments of the present invention there is provided a computer software product. The computer software product comprises a computer-readable medium in which program instructions are stored, which instructions, when read by a data processor, cause the data processor to execute the method as delineated above and optionally and preferably as further detailed below.

According to an aspect of some embodiments of the present invention there is provided a server system for processing an image. The server system comprises a transceiver arranged to receive and transmit image data on a communication network, and a processor arranged to communicate with the transceiver and execute the method as delineated above and optionally and preferably as further detailed below.

According to an aspect of some embodiments of the present invention there is provided a system for processing an image. The system comprises an imaging device for capturing image data from a scene, a displayed device, and a data processor. The data processor is configured to transmit the image data to a server, to receive from the server processed image data in which the captured image data is superimposed with a score describing a response of a subject to a food item or a representation of a food item contained in the captured image data, and to display on the display device a graphical user interface (GUI) containing an image corresponding to the processed image data.

According to some embodiments of the invention the data processor is configured to receive from the GUI a selection of the food item, to add the selection to a list of food items defining a meal, to transmit the list to the server, to responsively receive from the server a meal score for the list, and to display the meal score on the GUI.

According to an aspect of some embodiments of the present invention there is provided a method of displaying processed image content. The method comprising: capturing image data from a scene containing a food item or a representation of a food item; transmitting the image data to a server; receiving from the server processed image data in which the captured image data is superimposed with a score describing a response of a subject to the food item; and displaying on a display device a graphical user interface (GUI) containing an image corresponding to the processed image data.

According to some embodiments of the invention the capturing of the image data comprises capturing an image of a food item.

According to some embodiments of the invention the capturing of the image data comprises capturing an image of a food menu containing a textual content describing a plurality of food items.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method suitable for processing images, according to some embodiments of the present invention;

FIG. 2 is a schematic illustration of a client-server configuration which can be used according to some embodiments of the present invention for providing a subject with a personalized diet, according to some embodiments of the present invention; and

FIGS. 3A-E show a graphical user interface (GUI) which can be used according to some embodiments of the present invention.

### DESCRIPTION OF SPECIFIC EMBODIMENTS OF THE INVENTION

The present invention, in some embodiments thereof, relates to personalized diet and, more particularly, but not exclusively, to a method and system for improving a meal of an individual.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

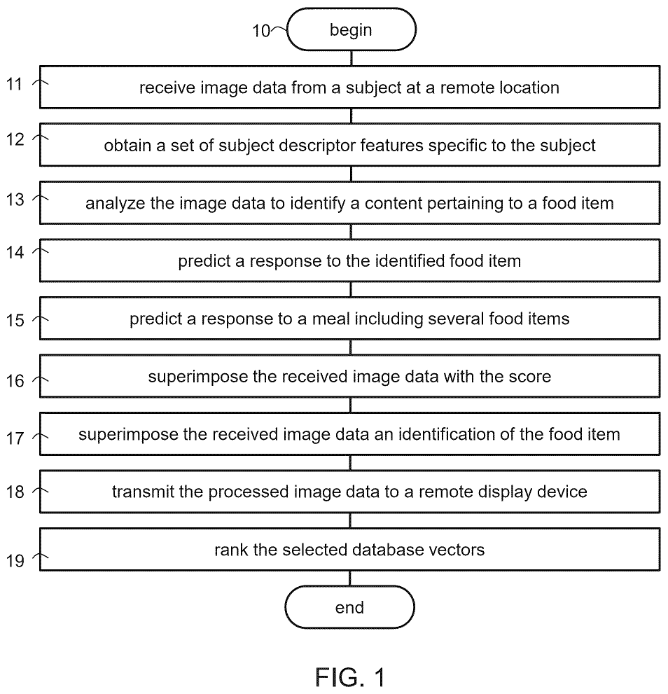

Referring now to the drawings, FIG. 1 is a flowchart diagram of a method suitable for processing images, according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

At least part of the operations described herein can be implemented by a data processing system, e.g., a dedicated circuitry or a general purpose processor, configured for executing the operations described below. At least part of the operations can be implemented by a cloud-computing facility at a remote location.

Computer programs implementing the method of the present embodiments can commonly be distributed to users by a communication network or on a distribution medium such as, but not limited to, a floppy disk, a CD-ROM, a flash memory device and a portable hard drive. From the communication network or distribution medium, the computer programs can be copied to a hard disk or a similar intermediate storage medium. The computer programs can be run by loading the code instructions either from their distribution medium or their intermediate storage medium into the execution memory of the computer, configuring the computer to act in accordance with the method of this invention. During operation, the computer can store in a memory data structures or values obtained by intermediate calculations and pull these data structures or values for use in subsequent operation. All these operations are well-known to those skilled in the art of computer systems.

Processing operations described herein may be performed by means of processer circuit, such as a DSP, microcontroller, FPGA, ASIC, etc., or any other conventional and/or dedicated computing system.

The method of the present embodiments can be embodied in many forms. For example, it can be embodied in on a tangible medium such as a computer for performing the method operations. It can be embodied on a computer-readable medium, comprising computer-readable instructions for carrying out the method operations. It can also be embodied in electronic device having digital computer capabilities arranged to run the computer program on the tangible medium or execute the instruction on a computer-readable medium.

The method of the present embodiments preferably processes image data for the purpose of providing a subject with a personalized diet. In various exemplary embodiments of the invention the method is executed on behalf of a service provider, such as, but not limited to, a provider of personalized diet recommendations. In these embodiments of the invention, the subject is a member of a group of identified subjects, each having an existing user account with the service provider, and the subject is requested to log into their user account to allow the method to provide the service to the identified subject.

The method begins at 10 and optionally and preferably continues to 11 at which image data is received from a subject at a remote location.

When the subject has an existing user account with the service provider, the method can identify the subject based on the user account and associate the received image data with the identified subject.

The image data can be captured by an imaging device at the remote location and be and transmitted to a server system for processing as described below. For example, an app of a mobile device (e.g., smartphone or a tablet or the like), can have permission (e.g., a user-enabled permission) to use the camera of the mobile device, and the subject can operate the camera-enabled app in order to capture the image data from the scene. The image data can be in the form of a single still image, or a set of still images, or a video image. A single still image is equivalent to a single frame of a video image, and is therefore referred to below as an image frame. The image data that is transmitted to the server system can also be a stream of image data, e.g., a sequence of image frames.

The imaged scene can include one or more physical food items, or one or more representations of food items, such as, but not limited to, an image or a sketch or an artificial object having a shape and optionally color of a food item, or a textual content describing one or more food items, such as, but not limited to, a food menu.

The method continues to 12 at which a set of subject descriptor features which are specific to the subject are obtained. Typically, these descriptor features are read from a computer-readable medium storing a set of descriptor features for each of a multiplicity of identified subjects having user account with the service provider. Alternatively, the descriptor features can be uploaded from the remote location as a datafile which is associated with the received meal.

The descriptor features typically also include general information such as gender, age, and preferably also a cohort to which the subject belongs. The cohort is typically a demographic cohort and is indicative of demographic characteristics of the subject, including, without limitation, a geographic origin of the subject, a geographic region at which the subject currently lives, cultural mores, and the like. The descriptor features can additionally include at least one of: a microbiome profile or a partial microbiome profile of the subject obtained by analyzing a stool sample of the subject, blood chemistry or partial blood chemistry of the subject [e.g., results of one or more tests such as, but not limited to, a triglyceride test, a glycosylated hemoglobin (HbA1c) test, a connecting peptide (C-peptide) test, a fasting plasma glucose (FPG) test, an oral glucose tolerance test (OGTT), and a casual plasma glucose test], genetic profile or partial genetic profile of the subject, metabolomic data associated with the subject, a medical condition of the subject. The descriptor features can optionally and preferably also include size parameters such as height, weight, and/or BMI. In experiments performed by the inventors the following descriptor features were employed: cohort, gender, age, height, weight, BMI, FPG test results, triglyceride test results, HbA1c test results, and microbiome related features extracted from a stool sample of the subject.

The method continues to 13 at which the image data are analyzed to identify therein a content pertaining to a food item. This can be done using any known image recognition techniques, such as, but not limited to, one of the image recognition methods disclosed in U.S. Pat. Nos. 10,860,930, 11,164,294, and 11,270,169, or one of the commercially software produces available from the Kooaba Company or the TiiiEye, Fiximilar, or PixMatch APIs from Idee, Inc. The analysis 13 can include tiling the image frame into a plurality of tiles, and analyzing the image data that correspond to each tile separately. In some embodiments of the present invention the method identifies in the image data different contents pertaining to different food items. The different food items can be contained within a single image frame (for example, in different tiles thereof) and/or in different image frames.

The method optionally and preferably continues to 14 at which the method predicts the subject's response to the food item. The prediction uses the set of subject descriptor features obtained at 12 and is therefore specific to the subject, that transmits the image data to the server. Preferably, the prediction is expressed by a numerical score that is indicative of the level by which the subject is responsive to the food item. Typically, the predicted response is a glycemic response of the subject to the food item, but other types of responses, such as, but not limited to, changes in the levels of cholesterol, sodium, potassium, and/or calcium, are also contemplated. Thus, the score can be indicative of the predicted glucose level and/or the predicted cholesterol level, and/or the predicted sodium level, and/or the predicted potassium level, and/or the predicted calcium kevel in the blood of the subject following consumption of the food item.

The prediction is optionally and preferably by means of a machine learning procedure trained to predict responses to food items based on subject descriptor features.

In machine learning, information can be acquired via supervised learning or unsupervised learning. In some embodiments of the invention the machine learning procedure comprises, or is, a supervised learning procedure. In supervised learning, global or local goal functions are used to optimize the structure of the learning system. In other words, in supervised learning there is a desired response, which is used by the system to guide the learning.

In some embodiments of the invention the machine learning procedure comprises, or is, an unsupervised learning procedure. In unsupervised learning there are typically no goal functions. In particular, the learning system is not provided with a set of rules. One form of unsupervised, learning according to some embodiments of the present invention, is unsupervised clustering in which the data objects are not class labeled, a priori.

Representative examples of “machine learning” procedures suitable for the present embodiments, including, without limitation, clustering, association rule algorithms, feature evaluation algorithms, subset selection algorithms, support vector machines, classification rules, cost-sensitive classifiers, vote algorithms, stacking algorithms, Bayesian networks, decision trees, neural networks, instance-based algorithms, linear modeling algorithms, k-nearest neighbors analysis, ensemble learning algorithms, probabilistic models, graphical models, regression methods, gradient ascent methods, singular value decomposition methods and principle component analysis. In some embodiments of the present invention the machine learning procedure is a procedure employing decision trees.

Following is an overview of some machine learning procedures suitable for the present embodiments.

Support vector machines are algorithms that are based on statistical learning theory. A support vector machine (SVM) according to some embodiments of the present invention can be used for classification purposes and/or for numeric prediction. A support vector machine for classification is referred to herein as “support vector classifier,” support vector machine for numeric prediction is referred to herein as “support vector regression”.

An SVM is typically characterized by a kernel function, the selection of which determines whether the resulting SVM provides classification, regression or other functions. Through application of the kernel function, the SVM maps input vectors into high dimensional feature space, in which a decision hyper-surface (also known as a separator) can be constructed to provide classification, regression or other decision functions. In the simplest case, the surface is a hyper-plane (also known as linear separator), but more complex separators are also contemplated and can be applied using kernel functions. The data points that define the hyper-surface are referred to as support vectors.

The support vector classifier selects a separator where the distance of the separator from the closest data points is as large as possible, thereby separating feature vector points associated with objects in a given class from feature vector points associated with objects outside the class. For support vector regression, a high-dimensional tube with a radius of acceptable error is constructed which minimizes the error of the data set while also maximizing the flatness of the associated curve or function. In other words, the tube is an envelope around the fit curve, defined by a collection of data points nearest the curve or surface.

An advantage of a support vector machine is that once the support vectors have been identified, the remaining observations can be removed from the calculations, thus greatly reducing the computational complexity of the problem. An SVM typically operates in two phases: a training phase and a testing phase. During the training phase, a set of support vectors is generated for use in executing the decision rule. During the testing phase, decisions are made using the decision rule. A support vector algorithm is a method for training an SVM. By execution of the algorithm, a training set of parameters is generated, including the support vectors that characterize the SVM. A representative example of a support vector algorithm suitable for the present embodiments includes, without limitation, sequential minimal optimization.

In KNN analysis, the affinity or closeness of objects is determined. The affinity is also known as distance in a feature space between objects. Based on the determined distances, the objects are clustered and an outlier is detected. Thus, the KNN analysis is a technique to find distance-based outliers based on the distance of an object from its kth-nearest neighbors in the feature space. Specifically, each object is ranked on the basis of its distance to its kth-nearest neighbors. The farthest away object is declared the outlier. In some cases the farthest objects are declared outliers. That is, an object is an outlier with respect to parameters, such as, a k number of neighbors and a specified distance, if no more than k objects are at the specified distance or less from the object. The KNN analysis is a classification technique that uses supervised learning. An item is presented and compared to a training set with two or more classes. The item is assigned to the class that is most common amongst its k-nearest neighbors. That is, compute the distance to all the items in the training set to find the k nearest, and extract the majority class from the k and assign to item.

Association rule algorithm is a technique for extracting meaningful association patterns among features.

The term “association”, in the context of machine learning, refers to any interrelation among features, not just ones that predict a particular class or numeric value. Association includes, but it is not limited to, finding association rules, finding patterns, performing feature evaluation, performing feature subset selection, developing predictive models, and understanding interactions between features.

The term “association rules” refers to elements that co-occur frequently within the datasets. It includes, but is not limited to association patterns, discriminative patterns, frequent patterns, closed patterns, and colossal patterns.

A usual primary step of association rule algorithm is to find a set of items or features that are most frequent among all the observations. Once the list is obtained, rules can be extracted from them.

The aforementioned self-organizing map is an unsupervised learning technique often used for visualization and analysis of high-dimensional data. Typical applications are focused on the visualization of the central dependencies within the data on the map. The map generated by the algorithm can be used to speed up the identification of association rules by other algorithms. The algorithm typically includes a grid of processing units, referred to as “neurons”. Each neuron is associated with a feature vector referred to as observation. The map attempts to represent all the available observations with optimal accuracy using a restricted set of models. At the same time the models become ordered on the grid so that similar models are close to each other and dissimilar models far from each other. This procedure enables the identification as well as the visualization of dependencies or associations between the features in the data.

Feature evaluation algorithms are directed to the ranking of features or to the ranking followed by the selection of features based on their impact.

Information gain is one of the machine learning methods suitable for feature evaluation. The definition of information gain requires the definition of entropy, which is a measure of impurity in a collection of training instances. The reduction in entropy of the target feature that occurs by knowing the values of a certain feature is called information gain. Information gain may be used as a parameter to determine the effectiveness of a feature in explaining the response to the treatment. Symmetrical uncertainty is an algorithm that can be used by a feature selection algorithm, according to some embodiments of the present invention. Symmetrical uncertainty compensates for information gain's bias towards features with more values by normalizing features to a [0,1] range.

Subset selection algorithms rely on a combination of an evaluation algorithm and a search algorithm. Similarly to feature evaluation algorithms, subset selection algorithms rank subsets of features. Unlike feature evaluation algorithms, however, a subset selection algorithm suitable for the present embodiments aims at selecting the subset of features with the highest impact on the subject's response, while accounting for the degree of redundancy between the features included in the subset. The benefits from feature subset selection include facilitating data visualization and understanding, reducing measurement and storage requirements, reducing training and utilization times, and eliminating distracting features to improve classification.

Two basic approaches to subset selection algorithms are the process of adding features to a working subset (forward selection) and deleting from the current subset of features (backward elimination). In machine learning, forward selection is done differently than the statistical procedure with the same name. The feature to be added to the current subset in machine learning is found by evaluating the performance of the current subset augmented by one new feature using cross-validation. In forward selection, subsets are built up by adding each remaining feature in turn to the current subset while evaluating the expected performance of each new subset using cross-validation. The feature that leads to the best performance when added to the current subset is retained and the process continues. The search ends when none of the remaining available features improves the predictive ability of the current subset. This process finds a local optimum set of features.

Backward elimination is implemented in a similar fashion. With backward elimination, the search ends when further reduction in the feature set does not improve the predictive ability of the subset. The present embodiments contemplate search algorithms that search forward, backward or in both directions. Representative examples of search algorithms suitable for the present embodiments include, without limitation, exhaustive search, greedy hill-climbing, random perturbations of subsets, wrapper algorithms, probabilistic race search, schemata search, rank race search, and Bayesian classifier.

A decision tree is a decision support algorithm that forms a logical pathway of steps involved in considering the input to make a decision.

The term “decision tree” refers to any type of tree-based learning algorithms, including, but not limited to, model trees, classification trees, and regression trees.

A decision tree can be used to classify the datasets or their relation hierarchically. The decision tree has tree structure that includes branch nodes and leaf nodes. Each branch node specifies an attribute (splitting attribute) and a test (splitting test) to be carried out on the value of the splitting attribute, and branches out to other nodes for all possible outcomes of the splitting test. The branch node that is the root of the decision tree is called the root node. Each leaf node can represent a classification or a value. The leaf nodes can also contain additional information about the represented classification such as a confidence score that measures a confidence level in the represented classification (i.e., the likelihood of the classification being accurate). For example, the confidence score can be a continuous value ranging from 0 to 1, in which a score of 0 indicating a very low confidence (e.g., the indication value of the represented classification is very low) and a score of 1 indicating a very high confidence (e.g., the represented classification is almost certainly accurate).

Regression techniques which may be used in accordance with some embodiments the present invention include, but are not limited to linear Regression, Multiple Regression, logistic regression, probit regression, ordinal logistic regression ordinal Probit-Regression, Poisson Regression, negative binomial Regression, multinomial logistic Regression (MLR) and truncated regression.

A logistic regression or logit regression is a type of regression analysis used for predicting the outcome of a categorical dependent variable (a dependent variable that can take on a limited number of values, whose magnitudes are not meaningful but whose ordering of magnitudes may or may not be meaningful) based on one or more predictor variables. Logistic regression may also predict the probability of occurrence for each data point. Logistic regressions also include a multinomial variant. The multinomial logistic regression model is a regression model which generalizes logistic regression by allowing more than two discrete outcomes. That is, it is a model that is used to predict the probabilities of the different possible outcomes of a categorically distributed dependent variable, given a set of independent variables (which may be real-valued, binary-valued, categorical-valued, etc.). For binary-valued variables, a cutoff between the 0 and 1 associations is typically determined using the Yuden Index.

A Bayesian network is a model that represents variables and conditional interdependencies between variables. In a Bayesian network variables are represented as nodes, and nodes may be connected to one another by one or more links. A link indicates a relationship between two nodes. Nodes typically have corresponding conditional probability tables that are used to determine the probability of a state of a node given the state of other nodes to which the node is connected. In some embodiments, a Bayes optimal classifier algorithm is employed to apply the maximum a posteriori hypothesis to a new record in order to predict the probability of its classification, as well as to calculate the probabilities from each of the other hypotheses obtained from a training set and to use these probabilities as weighting factors for future predictions of the subject's response. An algorithm suitable for a search for the best Bayesian network, includes, without limitation, global score metric-based algorithm. In an alternative approach to building the network, Markov blanket can be employed. The Markov blanket isolates a node from being affected by any node outside its boundary, which is composed of the node's parents, its children, and the parents of its children.

Instance-based techniques generate a new model for each instance, instead of basing predictions on trees or networks generated (once) from a training set.

The term “instance”, in the context of machine learning, refers to an example from a dataset.

Instance-based techniques typically store the entire dataset in memory and build a model from a set of records similar to those being tested. This similarity can be evaluated, for example, through nearest-neighbor or locally weighted methods, e.g., using Euclidian distances. Once a set of records is selected, the final model may be built using several different techniques, such as the naive Bayes.

Neural networks are a class of algorithms based on a concept of inter-connected “neurons.” In a typical neural network, neurons contain data values, each of which affects the value of a connected neuron according to connections with pre-defined strengths, and whether the sum of connections to each particular neuron meets a pre-defined threshold. By determining proper connection strengths and threshold values (a process also referred to as training), a neural network can achieve efficient recognition of images and characters. Oftentimes, these neurons are grouped into layers in order to make connections between groups more obvious and to each computation of values. Each layer of the network may have differing numbers of neurons, and these may or may not be related to particular qualities of the input data.

In one implementation, called a fully-connected neural network, each of the neurons in a particular layer is connected to and provides input value to those in the next layer. These input values are then summed and this sum compared to a bias, or threshold. If the value exceeds the threshold for a particular neuron, that neuron then holds a positive value which can be used as input to neurons in the next layer of neurons. This computation continues through the various layers of the neural network, until it reaches a final layer. At this point, the output of the neural network routine can be read from the values in the final layer. Unlike fully-connected neural networks, convolutional neural networks operate by associating an array of values with each neuron, rather than a single value. The transformation of a neuron value for the subsequent layer is generalized from multiplication to convolution.

The machine learning procedure used according to some embodiments of the present invention is a trained machine learning procedure. A machine learning procedure can be trained according to some embodiments of the present invention by feeding a machine learning training program with microbiome data of a cohort of subjects for which the response to the food items have been determined by blood tests. Once the data are fed, the machine learning training program generates a trained machine learning procedure of a selected type which can then be used without the need to re-train it.

A machine learning procedure suitable for the present embodiments is described in International Publication No. WO2015/166489, and in [Zeevi et al. Personalized nutrition by prediction of glycemic responses. Cell. 2015; 163(5): 1079-1094. doi: 10.1016/j. cell.2015.11.001] the contents of which are hereby incorporated by reference.

The trained machine learning procedure thus receives, as input, the set of subject descriptor features and the identified food item, and provides, as an output, a score indicative of the predicted response of the subject to the identified food item. When there is a plurality of different identified food items, the trained machine learning procedure is preferably applied separately to each of the food items to provide a separate score for each food item.

In some embodiments of the present invention the method proceeds to 15 at which the subject's specific response to a meal that includes two or more food items is predicted. This can be done by predicting the response to each of the food items that compose the meal to provide a score for each individual food item and then combining the scores of the individual food items to provide a meal score. The scores of the individual food items can be combined by averaging or using any other statistical measure that combines scores. Preferably, the method employ weights for performing the combination. Typically, the weights are based on the relative amounts (e.g., mass, volume) of the individual food items that compose the meal. For example, suppose that the meal is compose of m₁ grams of food item f₁, m₂ grams of food item f₂, and m₃ grams of food item f₃, and that the scores of these food items are s₁, s₂, s₃, respectively. Suppose further that the meal score is calculated as a weighted average of s₁, s₂, s₃. In this case the meal score is (m₁·s₁+m₂·s₂+m₃·s₃)/(m₁+m₂+m₃).

The food items in the meal can be the food items that are identified at 13. Alternatively, the meal can be composed of one or more food items that are identified at 13, and one or more additional food items that are provided by the subject to the server. Typically, the additional food items is selected by a subject at the remote location from a predefined list of food items. For example, the subject can operate a graphical user interface (GUI) in order to select the food items. The GUI can be a web page or a GUI of the app of the mobile device. Preferably, the GUI includes a display of multiplicity of food items, and a respective multiplicity of GUI selection controls allowing the subject to select individual food items one by one or in groups to define the meal. Controls activated by the subject can be communicated from the GUI to a data processor of a computer or the mobile device, and the data processor can process the controls, identify which food items have been selected by the subject, and transmit data pertaining to these food items over a communication network to the server.

Once the score or scores are obtained, the method can proceed to 16 at which at least a portion of the received image data is superimposed with one or more of the scores obtained at 14 and optionally also at 15, thus generating processed image data. When there is a score for each of a plurality of food items, the received image data or a portion thereof is optionally and preferably superimposed with each of the scores. Also contemplated are embodiments in which received image data or a portion thereof is superimposed with each the scores of the individual food items, but not with the meal score, which may be communicated to the subject over a different channel.

In some embodiments of the present invention the method proceeds to 17 at which the received image data or a portion thereof is superimposed also with an identification of the food item. The identification can be a textual identification or a recognizable symbol.

The superimposing 16 and 17 is preferably done such that once the processed image data are displayed the score and optionally the identification are visually associated with the image of the respective food item (e.g., displayed at the vicinity of the image of food item or with a pointer to the image of food item).

The method can then proceed to 18 at which the processed image data are transmitting to a display device viewable by the subject at the remote location. For example, the app of the mobile device can have a live view mode in which the app displays on the display of the mobile device the image as captured by the camera of the mobile device except that it is superimposed with the score(s) and optionally also the identifications as further detailed hereinabove.

The subject can then operate the app to switch a screen providing a list of food items composing a meal, and update the meal with one or more of the food items that are identified on the processed image, the server can then retrieve the updated meal from the app, calculate a meal score as further detailed hereinabove and transmit it back to the app for displaying on the display. Alternatively, or additionally, the subject can select a list of food items before capturing the image, in which case, the server can transmit to the app both the individual food item score(s) and the meal score.

### The Method Ends at 19.

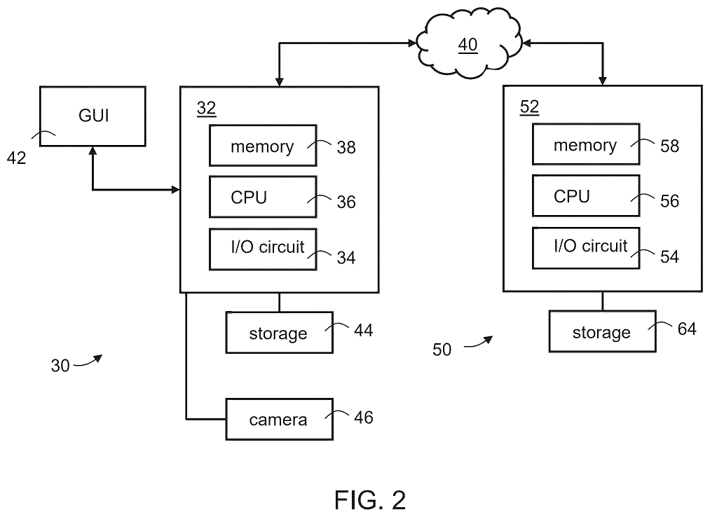

The method of the present embodiments can be executed according to some embodiments of the present invention by a server-client configuration, as will now be explained with reference to FIG. 2.

FIG. 2 illustrates a client computer 30 having a hardware processor 32, which typically comprises an input/output (I/O) circuit 34, a hardware central processing unit (CPU) 36 (e.g., a hardware microprocessor), and a hardware memory 38 which typically includes both volatile memory and non-volatile memory. CPU 36 is in communication with I/O circuit 34 and memory 38. Client computer 30 preferably comprises a user interface, e.g., a graphical user interface (GUI), 42 in communication with processor 32. I/O circuit 34 preferably communicates information in appropriately structured form to and from GUI 42. Client computer 30 also communicates with a camera 46, which can be used for capturing an image of a scene having one or more food items or representations thereof.

Also shown is a server computer 50 which can similarly include a hardware processor 52, an I/O circuit 54, a hardware CPU 56, a hardware memory 58. I/O circuits 34 and 54 of client 30 and server 50 computers preferable operate as transceivers that communicate information with each other via a wired or wireless communication. For example, client 30 and server 50 computers can communicate via a network 40, such as a local area network (LAN), a wide area network (WAN) or the Internet. Server computer 50 can be in some embodiments be a part of a cloud computing resource of a cloud computing facility in communication with client computer 30 over the network 40.

GUI 42 and processor 32, and optionally and preferably also camera 46, can be integrated together within the same housing. Alternatively, they can be separate units communicating with each other. GUI 42 can optionally and preferably be part of a system including a dedicated CPU and I/O circuits (not shown) to allow GUI 42 to communicate with processor 32. Processor 32 issues to GUI 42 graphical and textual output generated by CPU 36. Processor 32 also receives from GUI 42 signals pertaining to control commands generated by GUI 42 in response to user input. Processor 32 can also issue activation signals to camera 46 which can in turn provide processor 32 signals carrying image data describing images captured by camera 46.

GUI 42 can be of any type known in the art, such as, but not limited to, a keyboard and a display, a touch screen, and the like. In preferred embodiments, GUI 42 is a GUI of a mobile device such as a smartphone, a tablet, a smartwatch and the like, and camera 46 is a camera of the mobile device. When GUI 42 is a GUI of a mobile device, the CPU circuit of the mobile device can serve as processor 32 and can execute the method optionally and preferably by executing code instructions.

Client 30 and server 50 computers can further comprise one or more computer-readable storage media 44, 64, respectively. Media 44 and 64 are preferably non-transitory storage media storing computer code instructions for executing the method of the present embodiments, and processors 32 and 52 execute these code instructions. The code instructions can be run by loading the respective code instructions into the respective execution memories 38 and 58 of the respective processors 32 and 52. Storage media 64 preferably also store one or more databases including a database of psychologically annotated olfactory perception signatures as further detailed hereinabove.

In operation, the subject operates camera 46 to capture an image of a scene that includes one or more physical food items, or one or more representations of food items. Typically, the subject launches an app of the mobile device, which provides a set of activation controls. The subject operates an activation control that activates the camera 46, for example, in a live view mode. Processor 32 of client computer 30 receives image data from camera 46 and transmits it to server computer 50 over network 40. Processor 52 of server computer 50 can identify the subject, for example, based on an authentication protocol between computers 30 and 50, and obtain e.g., from media 64, a set of subject descriptor features that are specific to the subject. Processor 52 can execute object recognition instructions stored on media 64 to analyze the image data and identify therein a content pertaining to a food item, and then feed a trained machine learning procedure stored on media 64 with the identified food item(s) and set of subject descriptor features to provide a score describing a response of the subject to the food item, as further detailed hereinabove.

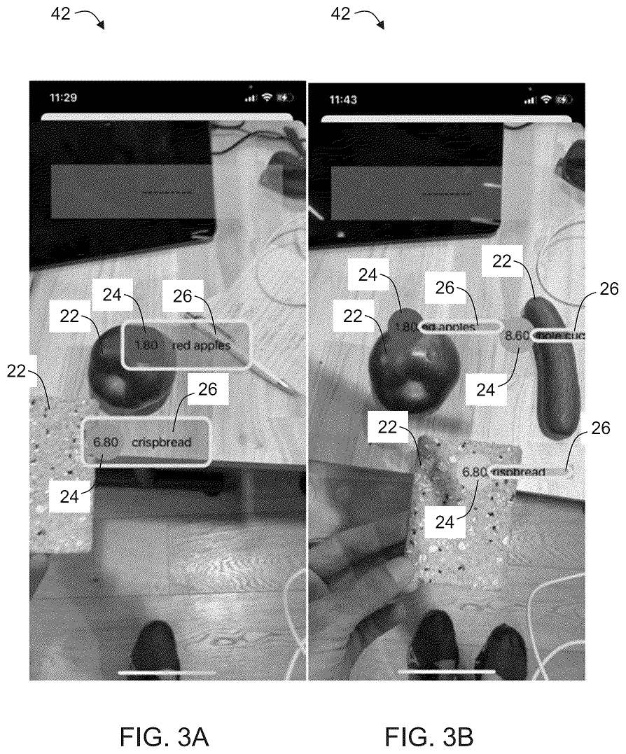

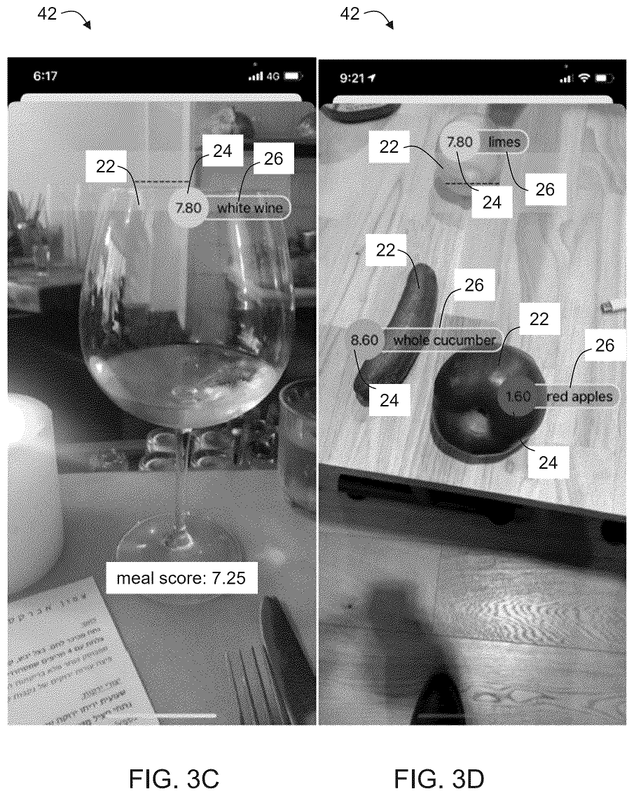

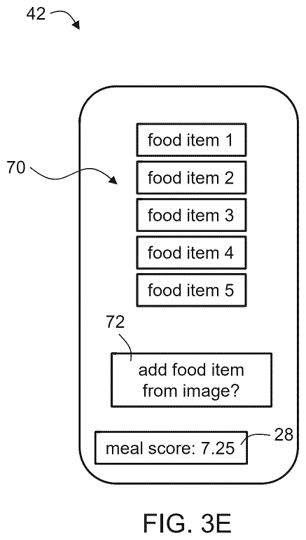

Processor 52 can then generate processed image data containing the score superimposed on at least a portion of the received image data, and transmit the processed image data to client computer 30 for displaying the image data as an image on GUI 42. Representative examples of screens displayed by GUI 42 are shown in FIGS. 3A-D, showing various types of food items 22, and corresponding scores 24, and identification texts 26. FIG. 3D also shows a display of a meal score. In the exemplified embodiment, the meal score is superimposed on the image as captured by the user. FIG. 3E illustrates an embodiment in which the meal score is shown on a screen of GUI 42 which allows the subject to selects food items from a list 70, and also includes a control 72 for allowing the subject to include in the list the food item(s) that was or were identified from the captured image. The meal score in this case is provided as an information control 28.

As used herein the term “about” refers to ±10 %

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of processing an image, comprising:
receiving image data from a subject at a remote location;
analyzing said image data to identify therein a content pertaining to a food item;
obtaining a set of subject descriptor features specific to said subject;
applying a trained machine learning procedure to said food item and said set to provide a score describing a response of said subject to said food item;
generating processed image data containing said score superimposed on at least a portion of said received image data; and
transmitting said image data to a display device viewable by said subject at said remote location.

2. The method according to claim 1, wherein said analyzing said image data comprises identifying non-textual content in the image.

3. The method according to any of claims 1 and 2, wherein said analyzing said image data comprises applying character recognition to a textual content in the image.

4. The method according to any of claims 1-3, wherein said image data comprises a stream of image data, and said processed image data comprises a stream of processed image data.

5. The method according to any of claims 1-4, wherein said generating said processed image data comprises superimposing also an identification of said food item.

6. The method according to any of claims 1-5, wherein said analyzing said image data comprises identifying in said image data different contents pertaining to different food items, wherein said applying said trained machine learning procedure comprises applying said trained machine learning procedure separately to each of said food items to provide a score describing a response of said subject to each of said food items, and wherein said generating said processed image data comprises superimposing each of said scores on at least a portion of said received image.

7. The method according to claim 6, wherein at least two of said different contents are in a single image frame.

8. The method according to claim 6, wherein at least two of said different contents are in different image frames.

9. The method according to any of claims 6-8, comprising calculating a meal score for a selection of said food items, and transmitting said meal score to said display device.

10. The method according to claim 9, wherein said selection comprises all said food items.

11. The method according to claim 9, wherein said selection comprises a portion of said food items.

12. The method according to claim 11, wherein said portion is selected automatically.

13. The method according to claim 11, comprising receiving said portion from said subject at said remote location.

14. A computer software product, comprising a computer-readable medium in which program instructions are stored, which instructions, when read by a data processor, cause the data processor to execute the method according to any of claims 1-13.

15. A server system for processing an image, the server system comprising:
a transceiver arranged to receive and transmit image data on a communication network; and
a processor arranged to communicate with the transceiver, and execute the method according to any of claims 1-14.

16. A system for processing an image, comprising:
an imaging device for capturing image data from a scene;
a displayed device; and
a data processor configured to transmit said image data to a server, to receive from said server processed image data in which said captured image data is superimposed with a score describing a response of a subject to a food item or a representation of a food item contained in said captured image data, and to display on said display device a graphical user interface (GUI) containing an image corresponding to said processed image data.

17. The system according to claim 16, wherein said data processor is configured to receive from said GUI a selection of said food item, to add said selection to a list of food items defining a meal, to transmit said list to said server, to responsively receive from said server a meal score for said list, and to display said meal score on said GUI.

18. A method of displaying processed image content, comprising:
capturing image data from a scene containing a food item or a representation of a food item;
transmitting said image data to a server;
receiving from said server processed image data in which said captured image data is superimposed with a score describing a response of a subject to said food item; and
displaying on a display device a graphical user interface (GUI) containing an image corresponding to said processed image data.

19. The method according to claim 18, wherein said capturing said image data comprises capturing an image of a food item.

20. The method according to claim 18, wherein said capturing said image data comprises capturing an image of a food menu containing a textual content describing a plurality of food items.
